(19) United States
(12) Patent Application Publication
(10) Pub. No.: US 2018/0352287 A1
(43) Pub. Date: Dec. 6, 2018

(54) Persistent ID for Offline Access to Streamed Media

(71) Applicant: Apple Inc., Cupertino, CA (US)

(72) Inventors: John Y. Su, Sunnyvale, CA (US); Jordan B. Schneider, San Francisco, CA (US); Michel A. Rynderman, San Jose, CA (US)

(21) Appl. No.: 15/613,029

(22) Filed: Jun. 2, 2017

(51) Int. Cl. H04N 21/433; H04L 29/08; H04N 21/432; H04N 21/44

(52) U.S. Cl. CPC H04N 21/4331; H04N 21/44012; H04N 21/4325; H04L 67/2842

(57) ABSTRACT

The present disclose describes techniques for delivery and playback of media using identifiers for offline playback, According to these techniques, a segment of media to be played may be identified from a manifest file. It may be determined whether the identical segment is available in local storage. When the identified segment is available in local storage, an identifier of the identified segment contained in the manifest file may be compared to an identifier of the segment in local storage. If the identifiers match, the segment may be played from local storage. Otherwise, the identified segment may be retrieved from a network location.

### BACKGROUND

The present disclosure relates to techniques for managing access to media streamed by computer networks.

Media streaming involves the delivery of multimedia data across a computer or communication network. In many cases, data of a media item is available at a media source on the network. A client device may request download of elements from the media item and, once received, the downloaded media data is rendered at the client device. Typically, streamed media is discarded once rendered.

In some use cases, however, a client device may be controlled to render a single media item multiple times. In such cases, network resources may be conserved if elements of a media item that are downloaded to a client device are stored for re-use. Storage operations are inherently speculative, however, because a client device does not have information to identify which media items will be replayed and which will not. Additionally, media items often are published with several different representations, called “streams;” due to changes in operator requirements or to changes in device operation state, a client device may render a different stream on replay than was played during a first playback operation. And, as a further complication, authors of a media item may alter the media item from one playback operation to the next, which may cause a client device to render a “stale” version when playing media from local storage.

The inventors perceive a need in the art for an improved protocol between media source and client device for media streaming, which provides for efficient caching of streamed media content.

### BRIEF DESCRIPTION OF THE DRAWINGS

The foregoing and other aspects of various embodiments of the present disclosure will be apparent through examination of the following detailed description thereof, in conjunction with the accompanying drawing figures in which similar reference numbers are used to indicate functionally similar elements.

FIG. 1 is an illustration of an example system according to an embodiment of the present disclosure.

FIG. 2 is a flow diagram of an example system according to an embodiment of the present disclosure.

FIG. 3 is an illustration of an example system according to an embodiment of the present disclosure.

FIG. 4 is an illustration of an example system according to an embodiment of the present disclosure.

FIG. 5 is an illustration of an example system according to an embodiment of the present disclosure.

FIG. 6 is a schematic diagram of an example computing system according to an embodiment of the present disclosure.

### DETAILED DESCRIPTION

Embodiments of the present disclosure provide techniques for media delivery and playback using identifiers for offline playback. According to these techniques, media items are marked with an identifier that represents a version of the media item, typically, in a manifest file of the media item. Client devices that cache content may store downloaded segments with identifiers that are derived from the manifest file's identifier. When replaying a media item, a client device may download a current version of the manifest file and its identifier. The client device may determine whether a desired segment is available in local storage. When the identified segment is available in local storage, the client device may compare an identifier of the identified segment as shown in the manifest file to an identifier of the segment as shown in local storage. If the identifiers match, the segment may be played from local storage. Otherwise, the identified segment may be retrieved from a network location.

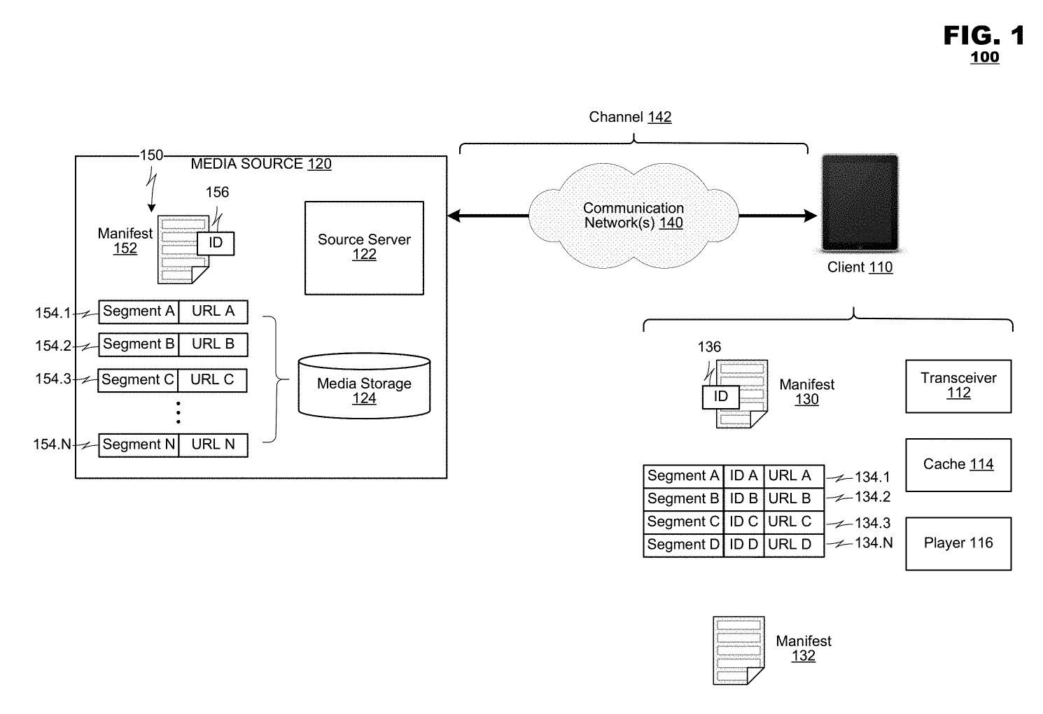

FIG. 1 is a simplified functional block diagram of an exemplary media delivery system 100 according to an embodiment of the present disclosure. The system 100 may include a client device 110 and a media source 120 interconnected via one or more communication network(s) 140. The media source 120 may furnish media stream(s) to a client device 110 where it is rendered for playback.

The media source 120 may include a source server 122 that manages delivery of media items 150 in response to requests from client devices 110. A media storage 124 may store the media items that are to be delivered. One media item 150 is illustrated in FIG. 1; it may include a manifest file 152 and a media stream composed of a plurality of segments 154.1-154.N. The manifest file 152 may contain data that describes organization of the media item and the segments 154.1-154.N contained therein. For example, the manifest tile 152 may identify, for each segment 154.1, 154.2, etc., the duration of the segment and a network location (commonly, a URL) where the segment may be retrieved. In an embodiment, the manifest file 152 may store an identifier 156 representing identifier(s) of the media item's segments 154.1-154.N.

In practice, a single media item 150 (say, a video program) may contain several media streams. For example, a single media item 150 may contain several alternate representations of video content of the media item, perhaps at different video resolutions, frame rates or bit rate representations. Further, a single media item 150 may contain several alternate representations of audio content of the media item 150, perhaps in different languages or to include different content elements (e.g., program dialogue vs. director commentary). Still other streams may be provided with other content, for example, closed caption information. In the example of FIG. 1, only one stream is illustrated, represented by the segments 154.1-154.N. The principles of the present disclosure, however, apply to media items 150 composed of multiple media streams.

The client device 110 may include a transceiver 112, a cache 114 and a media player 116. The transceiver 112 may manage communication between the client device 110 and other network entities, including the media source 1201. The cache 114 may store content of media items that are downloaded to the client device 110. The media player 116 may render media segments that are selected for playback.

During operation, when playing a new media item 150 (one that is not already stored at the client device 110), a client device 110 may request a manifest file 152 for the media item 150 from the media source 120. When the media source 120 furnishes the requested manifest file 152, the client device 110 may store the manifest file locally as manifest file 130. The client device 110 thereafter may select media stream(s) from the manifest file 130 for playback, and may issue requests to download segments 154.1-154.N of the requested media stream using the network locations identified in the manifest file 130. The downloaded segments 154.1-154.N may be stored in the cache 114, shown as segments 134.1-134.N.

In an embodiment, cached segments 134.1-134.N may be stored with an identifier ID that is derived from an identifier 136 stored in the manifest the 130. In one embodiment, each segment may correspond with a separate identifier, as seen in FIG. 1. In other embodiments, a single identifier may apply universally to all segments in a particular media stream and/or media item. The identifier II) may indicate a version of the segment. In an embodiment, the identifiers may be used as a basis to determine if cached segments may be re-used for later playback operations. The identifier may be assigned based on content in the manifest file 130 through which the segments 134.1-134.N were downloaded.

When playing a media item 150 that has been stored already at the client device 110, a client device 110 may request a manifest file 152 for the media item 150 from the media source 120. When the media source 120 furnishes the requested manifest file 152, the client device 110 may store the manifest file locally (shown as a new manifest file 132 to distinguish it from the previous manifest file 130). The client device 110 thereafter may select media stream(s) from the manifest file for playback and identify segments from the stream that are required for playback. For each segment, the client device 110 may check its own cache 114 to determine if the segment is present therein. If so, and if the identifier stored for the cached segment (or cached media stream of which the cached segment is a part) matches an identifier identified in the new manifest file 132, then the cached segment may be used for playback. If not, then the client device 110 may issue a request to download a new version of the segment as identified in the new manifest file 132. ID this mariner, cached segments may be re-used for playback and communication resources of the client device 110 and the media source 120 may be conserved.

In an embodiment in which the identifier applies universally to a media stream, the logic as to whether the client 110 should issue the request to download a new version of the segment may instead cause the client 114 to request a new version of the media stream, rather than just the particular segment. For example, if the client 110 determines that a segment of a media stream is stored in the cache 114 and that an identifier associated with this segment (and its corresponding media stream as a whole) in the new manifest file 132 does not match the identifier for the cached media stream, the client 110 may request to download segments from a new version of the media stream identified in the new manifest file 132.

Segment identifiers may be developed in a variety of ways. In one embodiment, a manifest file 152 may store a single identifier 156 that applies universally to all segments of the media item 150. In this embodiment, when identifiers are stored for cached segments 134.1-134.N at a client device 110, the same identifier may be stored for all the segments. In another embodiment, a manifest file may store identifiers 156 individually for each segment or for all segments in a common stream. In such cases, identifiers for the cache segments 134.1-134.N may be different from segment to segment or may be different from segments of other streams that are downloaded and cached at the client device 110.

According to an embodiment of the present disclosure, the segments stored in the cache 114 may be referenced by the player 116 in lieu of downloading those segments from the media source 120. In particular, the client device 110 may apply logic described herein to not only allow locally cached segments to be referenced for playback, but also to identify when an updated or different segment is available from the media source 120 to replace an already cached segment. This may be achieved by storing the previous manifest file 130 for later reference when the media item is played at a later time.

As indicated, the new manifest file 132 may refer to a manifest file identifying segments of a media item required for a current instance of playback of the media item. The new manifest file 132 may represent a local copy of the manifest file 152 transmitted to the client device 110 by the media source 120 during current playback at the client device 110 of a media item (or portion thereof). By contrast, the previous manifest file 130 may represent a manifest file received and stored by the client device 110 from a previous playback of the same media item (or portion thereof) as that of the current playback session.

In one example use case, the segments on the media source 120 referenced in the previous manifest file 130 and the new manifest file 132 remain the same between the previous and the current playback sessions. In this case, there should be no need for the client device 110 to re-download the segments from the media source 120. There would be no benefit in doing so since the segment has not, in fact, changed between sessions. Rather, the client device 110 could perform the playback of the media item using the segments from cache 114.

In other cases, the manifest file 152 and corresponding copies of the manifest file 152 (e.g., the new manifest file 132 and the previous manifest file 130) may include an identifier. The identifier may remain constant over two or more iterations of the manifest file 152 (if the associated segment has not been changed). As some examples, the identifier may be associated with a particular segment of the media item, a subset of segments of the media item, or the media item as whole. The identifier may indicate that the associated segment on the media source 120 has been changed in some way. Or in the case that the identifier is associated with two or more segments of a media item or the media item as a whole, the identifier may indicate that at least one of these segments has been changed.

In an example in which the identifier is associated with a particular segment, instead of referencing the URL n the new manifest file 132 for the segment to determine if the segment has changed on the media source 120 between playback sessions, the client device 110 may reference the identifier in the new manifest file 132. The client device 110 may thereby determine if the segment has changed on the media source 120. For example, the identifier for the segment in the new manifest file 132 may be compared against the identifier for the corresponding segment in the previous manifest file 130. If the identifier in the new manifest file 132 is different than that in the previous manifest file 130, this may indicate that the segment has changed on the media source 120 and that the client device 110 should download the segment rather than use the segment stored in the cache 114, presuming that it even is stored in the cache 114. The client device 110 may download the file from the URL specified in the new manifest file 132, which may be the same or different that that specified in the previous manifest file 130.

If the identifier in the new manifest file 132 is the same as that in the previous manifest file 130, the client device 110 may determine that there has been no change to the segment on the media source 120 and the client device 110 may safely use the copy of the segment stored in the cache 114. Notably, the storage location and/or file name of the segment in the media storage 124 or other storage location (e.g., at a new media source) may be altered without causing the client device 110 to unnecessarily download the segment again.

In another example in which the identifier, is associated with a media item or media stream as a whole (or subset thereof), the identifier may indicate that at least one of the segments thereof has been changed on the media source 120. As described above, when a new playback session is initiated and the client receives the new manifest file 132, the identifier of the new manifest file 132 may be compared against the identifier of the previous manifest file 130. If the identifier is the same, the media item or subset thereof represented by the manifest file may be played from previously created copies in the cache 114. If the identifier is different'between the new manifest file 132 and previous manifest file 130, the segments identified in the new manifest file 132 may be downloaded from the media source 120 at the URLs specified in new manifest file 132 (which may be the same or different than the URLs specified in the previous manifest file 130).

The architecture presented in FIG. 1 illustrates entities that are involved in storing and decoding a single coded media stream. This architecture may be expanded to accommodate multiple instances of media sources 120 and client devices 110. Thus a single media source 120 may code and transmit multiple media streams to multiple clients and clients may receive media streams from multiple sources. Additionally, a single media source 120 may store and transmit a common media stream in a variety of different bit rates or a variety of different frame sizes to accommodate capabilities of different types of clients. Each coded variant of a media stream may be considered to be a different media resource for purposes of the present discussion.

The client device 110 may represent media players that download media items from the media source 120, decode the coded media resources, and render them for playback. For example, the client device 110 may be realized in the form of a mobile device, such as a smart phone, a tablet computer, or a laptop. As another example, the client device 110 may be a desktop computer. As yet another example, the client device 110 may be a set-top cable box, a digital media player, a gaming console, or the like.

The techniques described hereinabove may provide advantages to streaming systems. First, by providing identifiers in manifest files, client devices may determine whether cached data is valid for reuse without having to download new copies of the cached data. Further, the foregoing embodiments permit authors or distributors of media items to alter aspects of the media item that do not alter its validity at the client device. For example, while cache validation theoretically could be performed on other data contain in a manifest file (for example, the URLs of each segment), changes to such data might cause a client device to disqualify a cached segment from use even though the content of the segment is otherwise valid.

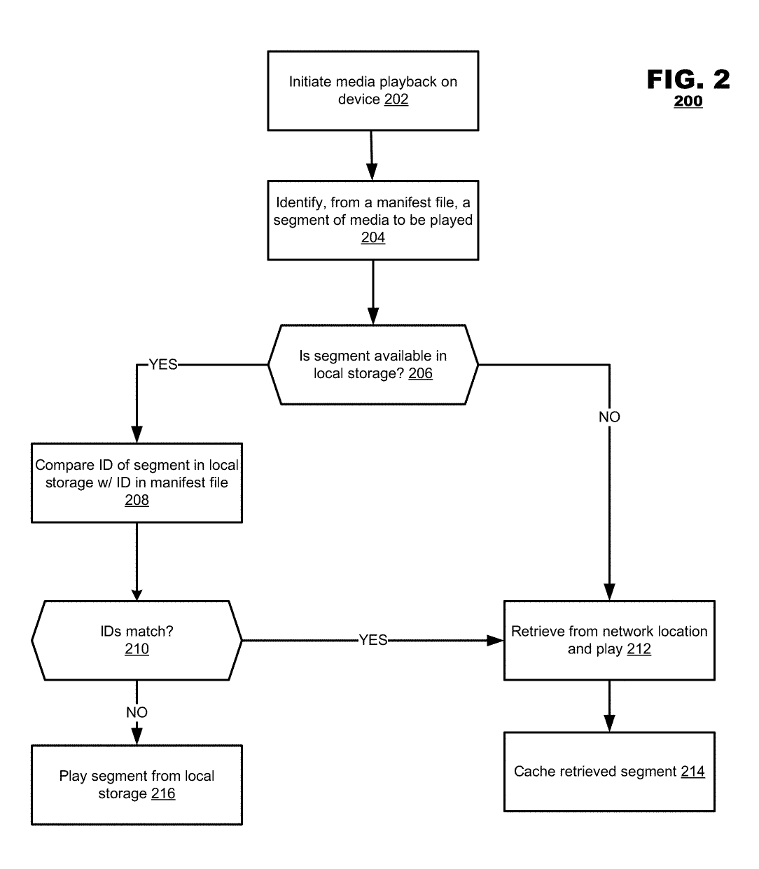

FIG. 2 illustrates a method 200 according to an embodiment of the present disclosure. The method 200 may begin when request for media playback is made (box 202). The method 200 may identify, from a manifest file, a segment of media to be played (box 204). The method 200 may determine whether the media segment is available in local storage (box 206). If the media segment is available in local storage, the method 200 may proceed to box 208. If the media segment is not available in local storage, the method 200 may instead proceed to box 212. If the media segment is available in local storage, the method 200 may compare an identifier of the identified segment, contained in the manifest file to an identifier of the segment in local storage (box 208). If the identifiers match, the method 200 may play the segment from the local storage (box 216). If the identifiers do not match, the method 200 may retrieve the identified segment from a network location and play it (box 212). The method 200 also may cache the retrieved segment for later use (box 214).

At box 206, if the segment identified in the manifest file is not available from local storage, the method 200 may advance to box 212, retrieve the identified segment from a network location and play it (box 212). Here, again, the retrieved segment may be cached in local storage for later use (box 214).

If the identifiers do not match and the identified segment must be retrieved from the network location, the identified segment may be downloaded to the local storage. Thereafter, this downloaded segment may be played from the local storage.

The identifier of the segment available in local storage may be represented in previous version of the manifest file that was previously downloaded. This previous manifest file may have been downloaded as part of a previous playback of the segment. For example, a user may have viewed a television program and also marked this television program for offline viewing. The manifest file used to effectuate this previous viewing may be later used in comparing an identifier for a segment in a manifest file for a new viewing of the television program.

In an embodiment, the network location from which the identified segment is retrieved may be indicated in the manifest file. However, if the identifiers do match, this network location may have no effect on whether the segment is played from the local storage or not. Rather, the segment may be played from the local storage even if the network location is different from that indicated in the previous manifest file. It is noted, however, that if the identifiers do not match, the new network location indicated in the new manifest file may be used instead of the old network location from the previously downloaded manifest file.

In an embodiment, the identifier of the segment that is available in local storage may be stored as part of the data of the segment. For example, the identifier may be indicated in metadata embedded in the segment.

In some embodiments, a change in the network location between a current manifest file and a previously downloaded manifest file may indicate a change in the directory and/or file name of the segment at the server which previously provided the segment. As another example, the change in the network location may indicate that the segment is now stored on and available from a different server from that which previously provided the segment.

In an alternative embodiment, the above technique may be applied to a plurality of media segments or even a whole media item. In such an embodiment, a plurality of segments to be played may be identified from a manifest file. It may be determined whether the plurality of segments is available in local storage. If the plurality of segments is available in local storage, a comparison may be performed between an identifier, contained in the above manifest file, for the plurality of segments and a corresponding identifier for the plurality of segments that are in local storage. If the identifiers match, the plurality of segments may be played from local storage. However, if the identifiers do not match, the plurality of segments may be received from a plurality of network locations, with each network location corresponding to a segment of the plurality of segments. When the plurality of segments is downloaded from the network locations to local storage, these newly-downloaded segments thereafter may be played from the local storage.

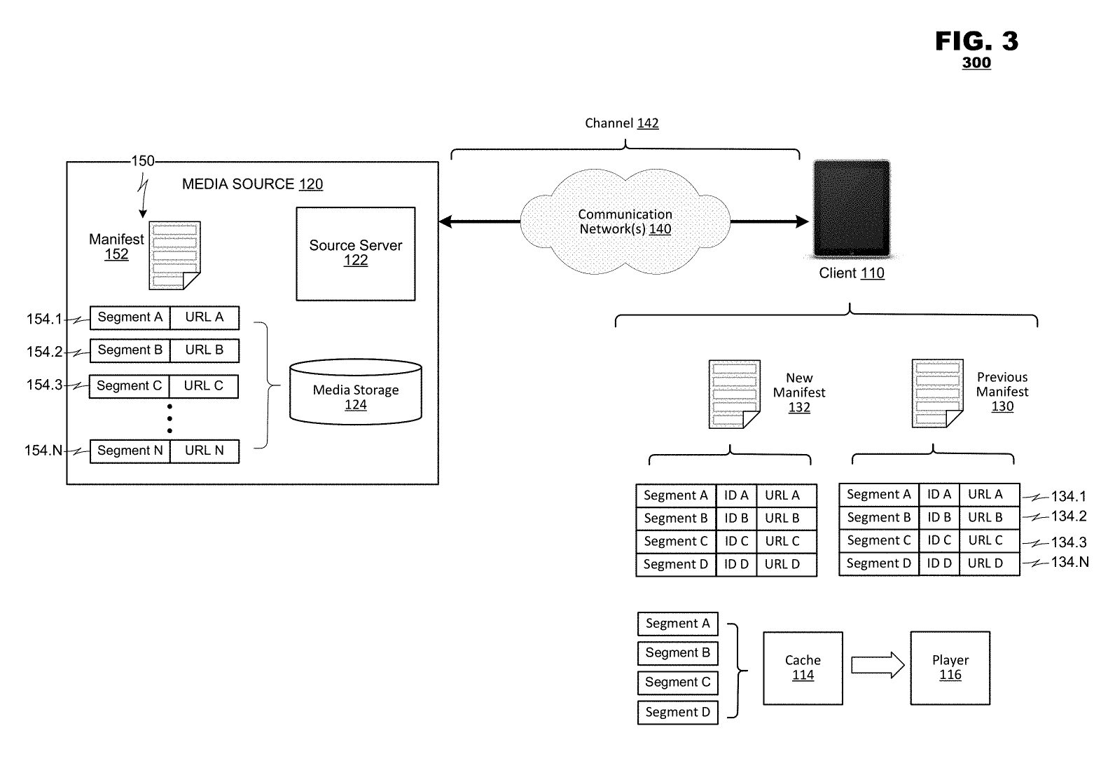

FIGS. 3-5 illustrate example use cases that may occur with respect to the system 100 shown in FIG. 1. Therefore, like reference characters between each of FIGS. 1 and 3-5 indicate like elements, unless otherwise indicated.

FIG. 3 illustrates a system 300 demonstrating an example use case using the system 100 of FIG. 1. Here, the client device 110 had previously requested for and received the manifest file 130 to effectuate a previous playback of at least a portion of the media item 150. At the instant time represented in the system 300, the client device 110 now initiates a further playback of the media item 150. Thus, the client device 110 requests for and receives the new manifest file 132 to effectuate this current playback.

in this use case, the segments 154.1-154.N of the media item 150 remain the same between the previous playback and the current playback of the media item 150. Thus, the identifiers (ID A, ID B, etc.) remain the same between the new manifest file 132 and the previous manifest file 130. Accordingly, there is no need for the client device 110 to re-download the segments for the current playback of the media item 150. There would be no apparent benefit in doing so since the segments have not, in fact, changed between playback sessions. Rather, the client device 110 could perform the current playback of the media item 150 using the segments in cache 114 from the previous playback.

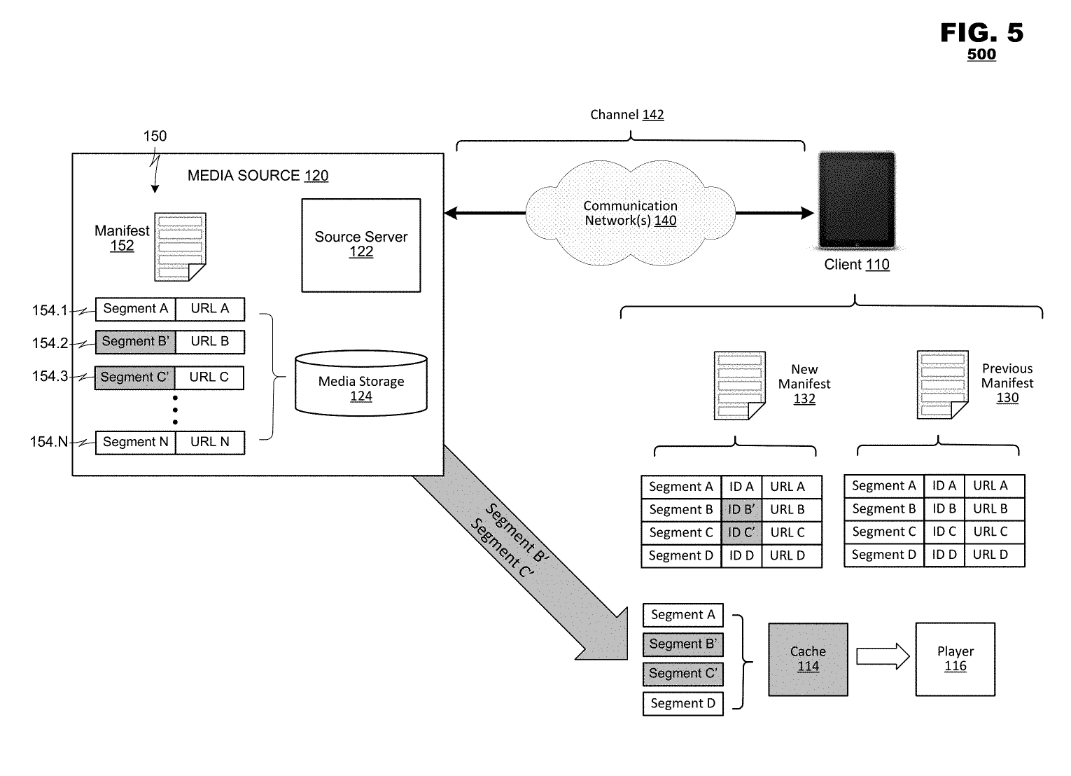

To determine whether the client device 110 could perform the current playback of the media item 150 using the segments in the cache 114, each of the identifiers in the previous manifest file 130 and the corresponding identifiers in the new manifest file 132 may be compared against one another. Here, the identifiers in the previous manifest file 130 and the new manifest file 132 each match (e.g., ID A of the new manifest file 132 matches the ID A of the previous manifest file 130, and so forth). The client device 110, therefore, may use the segments already stored in the cache 114 for the current playback. The cases in which the identifiers between the two manifest files do not match will be discussed further in relation to FIG. 5.

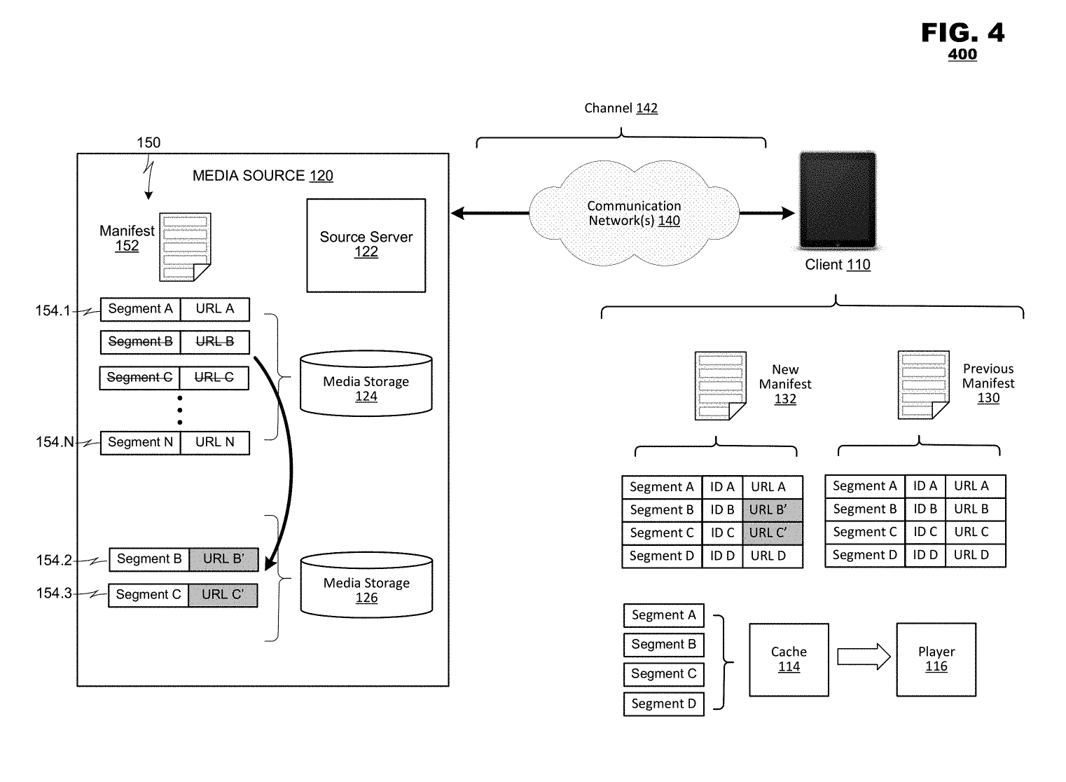

FIG. 4 illustrates a system 400 demonstrating an additional example use case scenario. In the system 400, segment B and segment C (154.2, 154.3) have been moved to a different storage location at a second media storage 126. This may have occurred between the time of a previous playback of the media item (i.e., when the previous manifest file 130 was received at the client device 110) and a current playback of the media item. In the example shown in FIG. 4, the new storage location is within the same media source 120. However, the same principles may be applied if the second media storage 126 is part of a second media source and/or if the file names of segment B and/or segment C are modified. Suffice it to say that the respective URLs of segment B and segment C have been changed from their previous URLs. The new URLs are indicated, respectively, as URL B′ and URL C′.

While the URLs for segment B and segment C have changed since the previous playback, the segments themselves have not. Therefore, the identifiers (ID A, ID B, etc.) in the new manifest file 132 provided in response to initiation of the current playback may be the same as those in the previous manifest file 130. Of particular note is that the identifiers (ID B and ID C), in the new manifest file 132 and associated with the segment B and the segment C are unchanged over those in the previous manifest file 130, despite the change to the location of the respective storage locations.

After receiving the new manifest file 132, the client device 110 may compare the identifier associated with segment B in the new manifest file 132 with the identifier associated with segment B in the previous manifest file 130, and likewise with the identifiers associated with segment C. Here, the client device 110 will determine that these identifiers are the same. Accordingly, the client device 110 may access segment B and segment C from the cache 114 (as well as segment A and segment D since those respective identifiers have likewise remained unchanged) and use those segments from the cache 114 for playback via the player 116.

FIG. 5 illustrates a system 500 demonstrating yet another use case scenario. In the system 500, segment B (154.2) and segment C (154.3) remain at the same storage location as that of a previous playback. Yet here, segment B and segment C are themselves changed, indicated by the notations B′ and C′. These changes to segment B and segment C are indicated in the new manifest file 132 provided to the client device 110 by a change to the identifiers associated with segment B and segment C. The changes to these identifiers are indicated by the notations ID B′ and ID C′ in the new manifest file 132.

According to the above-described process, the identifiers of the new manifest file 132 and the identifiers of the previous manifest file 130 may be compared against one another. In this case, the client device 110 may identify that the identifier ID B′ and the identifier ID C′ is different with respect to the identifier ID B and the identifier ID C in the previous manifest file 130. Accordingly, the client device 110 may download the segment B′ and the segment C′ from the media source 120. The client device 110 may stores the segment B′ and the segment C′ in the cache 114, replacing the segment B and the segment C that previously resided in the cache 114. Further, since the identifier ID A and the identifier ID D in the new manifest file do match those in the previous manifest file, the client does not download the corresponding segments from the media source 120. Subsequent to downloading the segment B′ and the segment C′ and storing them in the cache 114, as well as determining that the segment A and the segment D do not need to be downloaded, the client device 110 may proceed with playback using the newly updated cache 114.

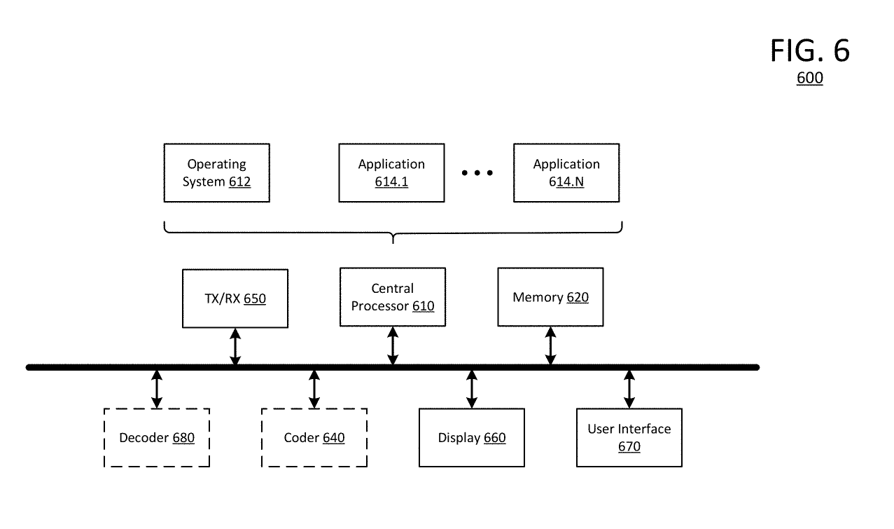

The techniques described herein may be performed by a central processor of a computer system. FIG. 6 illustrates an exemplary computer system 600 that may perform such techniques. For example, the client device 110 and/or the media source 120 of FIG. 1 may be realized in the form of the computer system 600. The computer system 600 may include a central processor 610 and a memory 620. The central processor 610 may read and execute various program instructions stored in the memory 620 that define an operating system 612 of the system 600 and various applications 614.1-614.N. For example, one of the applications 614.1-614.N may comprise the player 116 of FIG. 1. The program instructions may cause the processor to perform the various media segment management techniques to effectuate playback of those segments, as described herein.

As indicated, the memory 620 may store program instructions that, when executed, cause the processor 610 to perform the techniques described hereinabove. The memory 620 may store the program instructions on electrical-, magnetic- and/or optically-based storage media. The memory may comprise volatile and/or non-volatile memory. As a further example use of the memory 620, the memory 620 may realize the cache 114 of FIG. 1. Thus, the memory 620 may be configured to store and enable on-demand access to segments of a media item to a player for playback.

The system 600 may possess other components as may be consistent with the system's role as a media source, a media playback device, or both. The system 600 may possess a coder 640 to perform video coding on one or more media segments and a transmitter 650 (shown as TX) to transmit data out from the system 600. The coder 640 may be provided as a hardware device (e.g., a processing circuit separate from the central processor 610) or it may be provided in software as an application 614.1.

in a role as media playback device, the system 600 may possess a receiver 650 (shown as RX), a decoder 680, a display 660, and user interface elements 670. The receiver 650 may receive data and the decoder 680 may decode the data. For example, the client device 110 of FIG. 1 may receive coded media segments from the media source 120 of FIG. 1 and decode those coded media segments for playback. The display 660 may be a display device on which decoded media segments may be rendered. The user interface 670 may include component devices (such as motion sensors, touch screen inputs, keyboard inputs, remote control inputs anchor controller inputs) through which operators input data to the system 600.

Several embodiments of the present disclosure are specifically illustrated and described herein. However, it will be appreciated that modifications and variations of the present disclosure are covered by the above teachings and within the purview of the appended claims without departing from the spirit and intended scope of the disclosure.

1. A method for playing media, the method comprising:
identifying, from a current manifest file including a network location and a version identifier of segments of media, a segment of media to be played;
determining whether the identified segment is available in local storage,
when the identified segment is available in local storage, comparing a version identifier of the identified segment contained in the manifest file to a version identifier of the segment in local storage;
if the version identifiers match, playing the segment from local storage; and
otherwise, retrieving and playing the identified segment from a network location.

2. The method of claim 1, wherein the version identifier of the segment available in local storage is stored in another version of the manifest file, previously downloaded.

3. The method of claim 2, wherein the other version of the manifest file was used to effectuate a previous playback of the segment.

4. The method of claim 2, wherein the network location is indicated in the manifest file containing the version identifier of the identified segment.

5. The method of claim 4, wherein, if the version identifiers match, the segment is played from local storage regardless of whether the network location indicated in the manifest file represents a change of network location from that of a previous playback.

6. The method of claim 5, wherein the change in network location comprises a change in a file directory of the segment at the network location.

7. The method of claim 5, wherein the change in network location comprises a change in a filename of the segment at the network location.

8. The method of claim 5, wherein the change in network location comprises a change in a server hosting the segment.

9. The method of claim 1, wherein the version identifier of the segment available in local storage is stored as part of the data of the segment.

10. The method of claim 1, further comprising:
responsive to retrieving the identified segment from the network location, storing the segment retrieved from the network location to local storage; and
playing, from local storage, the segment previously retrieved from the network location.

11. The method of claim 1, wherein the segment available in local storage was used in a previous playback of the segment.

12. The method of claim 1, wherein the version identifier of the identified segment contained in the manifest file indicates a change to the identified segment in relation to the segment in the local storage.

13. A method for playing media, the method comprising:
identifying, from a manifest file, a plurality of segments of media to be played;
determining whether the plurality of segments are available in local storage;
when the plurality of segments are available in local storage, comparing a version identifier, contained in the manifest file, for the plurality of segments to a corresponding version identifier of the plurality of segments in local storage;
if the version identifiers match, playing the plurality of segments from local storage; and
otherwise, retrieving the plurality of segments from a corresponding plurality of network locations.

14. The method of claim 13, wherein the identifier of the plurality of segments available in local storage is stored in another version of the manifest file, previously downloaded.

15. The method of claim 14, wherein the other version of the manifest file was used to effectuate a previous playback of the plurality of segments.

16. The method of claim 14, wherein the plurality of network locations are indicated in the manifest file containing the identifier for the plurality of segments.

17. The method of claim 13, wherein the identifier of the plurality of segments in local storage is stored as part of the data of the plurality of segments.

18. The method of claim 13, wherein the plurality of segments in the local storage were used in a previous playback of the plurality of segments.

19. A computer-readable medium storing instructions that, when executed by a processor, effectuate operations comprising:
identifying, from a manifest file, a segment of media to be played;
determining whether the identified segment is available in local storage,
when the identified segment is available in local storage, comparing a version identifier of the identified segment contained in the manifest file to a version identifier of the segment in local storage;
if the version identifiers match, playing the segment from local storage; and
otherwise, retrieving the identified segment from a network location.

20. A computing device comprising:
a processor;
a memory in mutual communication with the processor and storing instructions that, when executed by the processor, effectuate operations comprising:
identifying, from a manifest file, a segment of media to be played;
determining whether the identified segment is available in local storage,
when the identified segment is available in local storage, comparing a version identifier of the identified segment contained in the manifest file to a version identifier of the segment in local storage;
if the identifiers match, playing the segment from local storage; and
otherwise, retrieving the identified segment from a network location.

21. The method of claim 1, further comprising, prior to the operations of claim 1:
identifying, from an original manifest, the network location and the version identifier of the segment in local storage;
retrieving the identified segment from the network location; and
storing the identified segment in local storage.
